(19) United States
(12) Patent Application Publication
(10) Pub. No.: US 2013/0193384 A1
(43) Pub. Date: Aug. 1, 2013

(54) POLYMER THICK FILM POSITIVE TEMPERATURE COEFFICIENT CARBON COMPOSITION

(71) Applicant: JAY ROBERT DORFMAN, Durham, NC (US)

(72) Inventor: JAY ROBERT DORFMAN, Durham, NC (US)

(73) Assignee: E. I. DU PONT DE NEMOURS AND COMPANY, Wilmington, DE (US)

(21) Appl. No.: 13/362,065

(22) Filed: Jan. 31, 2012

(51) Int. Cl. H01B 1/24

(52) U.S. Cl. 252/511

(57) ABSTRACT

The invention is directed to a polymer thick film positive temperature coefficient carbon resistor composition comprising: (a) organic medium comprising (i) organic polymeric binder; and (ii) solvent; and (b) conductive carbon powder. The composition may be processed at a time and temperature necessary to remove all solvent.

The invention is further directed to PTC circuits comprising the composition of the invention which has been dried to remove the solvent and to articles, e.g., mirror heaters and seat heaters, containing such PTC circuits.

### FIELD OF THE INVENTION

This invention is directed to a polymer thick film (PTF) positive temperature coefficient (PTC) carbon resistor composition for use in self-regulating heater circuits.

### BACKGROUND OF THE INVENTION

It is well known in the art that the electrical properties of conductive polymers frequently depend upon their temperature. A very small proportion of conductive polymers exhibit a positive temperature coefficient (PTC), i.e., rapid increase in resistivity at a particular temperature or over a particular temperature range. Materials exhibiting PTC behavior are useful in a number of applications in which the size of the current passing through a circuit is controlled by the temperature of a PTC element forming part of the circuit.

PTC circuits are typically used as self-thermostating circuits such as mirror heaters and seat heaters found in automobiles and the like. They are used in place of an external thermostat. Although they have been used for years in these types of applications, the PTC circuits typically have problems such as resistance shift stability, powered on/off cycling inconsistency, and sensitivity to the adhesive used in the fabrication. All these issues can and do have a negative impact on a functional PTC circuit. It is the purpose of this invention to help alleviate these issues and thus help produce a more efficient and reliable PTC circuit.

### SUMMARY OF THE INVENTION

The invention is directed to a polymer thick film positive temperature coefficient carbon resistor composition, comprising:
(a) 50 to 99% weight percent organic medium, comprising:
   (i) a fluoropolymer resin which is a copolymer of vinylidene difluoride and hexafluoropropylene; and
   (ii) an organic solvent, wherein the fluoropolymer resin is 10 to 50 weight percent of the total organic medium and is dissolved in the organic solvent; and
(b) 1 to 50% conductive carbon black powder, wherein the carbon black powder is dispersed in the organic medium and wherein the weight percent of the organic medium and the conductive carbon black powder are based on the total weight of the polymer thick film positive temperature coefficient carbon resistor composition.

The composition may be processed at a time and temperature necessary to remove all solvent.

The invention is further directed to PTC circuits comprising the composition of the invention which has been dried to remove the solvent and to articles, e.g., mirror heaters and seat heaters, containing such PTC circuits.

### DETAILED DESCRIPTION OF INVENTION

The invention describes a polymer thick film positive temperature coefficient carbon resistor composition and its use in forming active PTC carbon resistors in PTC heating circuits. It is typically used so as to provide heating of the total circuit. A layer of encapsulant is sometimes printed and dried on top of the active PTC carbon resistor.

Generally, a thick film composition comprises a functional phase that imparts appropriate electrically functional properties to the composition. The functional phase comprises electrically functional powders dispersed in an organic medium that acts as a carrier for the functional phase. Generally, the composition is fired to burn out the organics and to impart the electrically functional properties. However, in the case of polymer thick film compositions, the polymer or resin component remains as an integral part of the composition after drying and the removal of the solvent

The components of the polymer thick film positive temperature coefficient carbon resistor composition are discussed below.

### Organic Medium

The resin or polymer is typically added to a solvent to produce an “organic medium” having suitable consistency and rheology for printing. A wide variety of inert liquids can be used as organic medium. The organic medium must be one in which the solids are dispersible with an adequate degree of stability. The rheological properties of the medium must be such that they lend good application properties to the composition. Such properties include: dispersion of solids with an adequate degree of stability, good application of composition, appropriate viscosity, thixotropy, appropriate wettability of the substrate and the solids, a good drying rate, and a dried film strength sufficient to withstand rough handling.

The fluoropolymer resin used in this invention is a copolymer of vinylidene difluoride (VF2) and hexafluoropropylene (HFP) imparts important properties to the PTC composition. Specifically, the solubility of the resin in common organic solvents and the temperature stability found were different compared with those of other fluoropolymers tested. The copolymer of vinylidene difluoride and hexafluoropropylene which helps achieve both good adhesion to both the PTF silver layer and underlying substrate and is compatible with, and thus will not adversely affect, the PTC performance, two critical properties for PTC circuits. In an embodiment, this fluoropolymer resin may be 10 to 50%, 15 to 35%, or 22.5 to 27.5% of the total weight of the composition.

Solvents suitable for use in the polymer thick film composition are recognized by one of skill in the art and include acetate and terpenes such as alpha- or beta-terpineol or mixtures thereof with other solvents such as kerosene, dibutylphthalate, butyl carbitol, butyl carbitol acetate, hexylene glycol and high boiling alcohols and alcohol esters. In addition, volatile liquids for promoting rapid hardening after application on the substrate may be included in the vehicle. In many embodiments of the present invention, solvents such as glycol ethers, ketones, esters and other solvents of like boiling points (in the range of 180° C. to 250° C.), and mixtures thereof may be used. The preferred mediums are based on DiBasic Esters. Various combinations of these and other solvents are formulated to obtain the viscosity and volatility requirements desired. The solvents used must solubilize the resins.

### Conductive Powder

The conductive powder used in this invention is conductive carbon or carbon black which is required to achieve the target resistance (1-50 Kohm/sq) and the desired PTC effect. Other carbon powders and/or graphite may be used in conjunction with the conductive carbon black as well as combinations of non-conductive powders such as fumed silica. Other printing aids may be used. Common conductive powders such as silver and gold may also be used in combination with the carbon powder.

### Application of Thick Films

The polymer thick film composition also known as a “paste” is typically deposited on a substrate, such as polyester, that is impermeable to gases and moisture. The substrate can also be a sheet of a composite material made up of a combination of plastic sheet with optional metallic or dielectric layers deposited thereupon.

The deposition of the PTF PTC composition is performed preferably by screen printing, although other deposition techniques such as stencil printing, syringe dispensing or coating techniques can be utilized. In the case of screen-printing, the screen mesh size controls the thickness of deposited thick film.

The deposited thick film is dried, i.e., the solvent is removed, by exposure to heat for typically 10 to 15 min at 140° C.

In one embodiment, the PTF PTC carbon resistor composition is used as a screen-printed layer on top of a PTF silver composition such as DuPont 5064 silver conductive ink (DuPont Co., Wilmington , Del.).

The present invention will be discussed in further detail by giving a practical example. The scope of the present invention, however, is not limited in any way by these practical examples.

### EXAMPLE 1 AND COMPARATIVE EXPERIMENT A

### Example 1

The PTF PTC carbon resistor composition (paste) was prepared by first preparing the organic medium as follows: 25.0 wt % copolymer of vinylidene difluoride and hexafluoropropylene resin (RC-10,235 from Arkema Inc. King of Prussia, Pa.) was mixed with 75.0 wt % diibasic esters DBE™-9 (Invista™, Wilmington, Del.) organic solvent. The molecular weight of the resin was approximately 20,000. The above mixture was heated at 90° C. for 1-2 hours to dissolve all the resin and form the organic medium. Conductive carbon black Monarch® 120 (Cabot Corp., Boston, Mass.) was then added to the organic medium in the proper amount. The PTF PTC carbon resistor composition is given below:

| | |
|---|---|
| 82.72% | Organic Medium |
| 8.18 | Conductive Carbon Black Powder |
| 9.10 | DBE ™-9 Solvent |

This composition was mixed for 30 minutes on a planetary mixer. The composition was then transferred to a three-roll mill where it was subjected to one pass at 0 psi and one pass at 150 psi. The result was the PTF PTC carbon resistor composition.

Circuits were then fabricated as follows: Using a 280 mesh stainless steel screen, a series of interdigitated silver lines were printed on a polyester substrate using DuPont 5064 silver conductive ink (DuPont Co., Wilmington, Del.). This silver conductor was dried at 140° C. for 15 min in a forced air box oven. Next, a standard PTC circuit pattern of interdigitated lines made with the above PTF PTC carbon resistor composition which was printed and dried at 140° C. for 15 min in a forced air box oven as was done with the silver conductive ink. Properties of the PTC circuit were measured. The resistivity of the PTC paste was approximately 10 Kohm/sq. A summary table appears below:

### Comparative Experiment A

A PTC circuit was produced exactly as above using first DuPont 5064 silver conductive ink followed by DuPont 7282 Carbon Resistor Thick Film Composition (DuPont Co., Wilmington, Del.) on a polyester substrate. They were each dried at 140° C. for 15 min per the above. The only difference from Example 1 was that use of the DuPont 7282 Carbon Resistor Thick Film Composition instead of the PTF PTC carbon resistor composition of the invention. Properties of the PTC circuit are summarized below.

| | | Equilibrium Temp. Change |
|---|---|---|
| | Resistance Shift | Temperature Cycling |
| | 24 Hrs. @ 90° C. | (400 Cycles) |
| Example 1 | −2.5% | 5 Degree C. Shift |
| Comparative | −30.0% | 15 Degree C. Shift |
| Experiment A | | |

Additionally, the magnitude of the PTC effect as measured by the ratios of resistance at 65° C. /resistance at room temperature (about 25° C.) is increased by approximately 3× in Example 1 which is similar to that seen in Comparative Experiment A, but at half the initial resistance value, further demonstrating the improvement seen when using the composition with the VF2/HFP copolymer.

What is claimed is:

1. A polymer thick film positive temperature coefficient carbon resistor composition, comprising:
(a) 50 to 99% weight percent organic medium, comprising:
(i) a fluoropolymer resin which is a copolymer of vinylidene difluoride and hexafluoropropylene; and
(ii) an organic solvent, wherein the fluoropolymer resin is 10 to 50 weight percent of the total organic medium and is dissolved in the organic solvent; and
(b) 1 to 50% conductive carbon black powder, wherein the carbon black powder is dispersed in the organic medium and wherein the weight percent of the organic medium and the conductive carbon black powder are based on the total weight of the polymer thick film positive temperature coefficient carbon resistor composition.

2. The polymer thick film positive temperature coefficient carbon resistor composition of claim 1, further comprising fumed silica.

3. The polymer thick film positive temperature coefficient carbon resistor composition of claim 1, wherein the fluoropolymer resin is 15 to 35 weight percent of the total organic medium.

4. The polymer thick film positive temperature coefficient carbon resistor composition of claim 1, wherein the fluoropolymer resin is 22.5 to 27.5 weight percent of the total organic medium.

5. A positive temperature circuit comprising the polymer thick film positive temperature coefficient carbon resistor composition of any of claims 1-4, wherein the polymer thick film positive temperature coefficient carbon resistor composition has been dried to remove the solvent.

6. An article containing the positive temperature circuit of claim 5.

7. The article of claim 6 in the form of a mirror heater.

8. The article of claim 6 in the form of a seat heater.
